(19) United States
(12) Patent Application Publication
(10) Pub. No.: US 2025/0350082 A1
(43) Pub. Date: Nov. 13, 2025

(54) MESHED GEAR CABLE CONNECTOR FASTENING SYSTEM

(71) Applicant: Dell Products L.P., Round Rock, TX (US)

(72) Inventors: Bruce Anthony Holmes, Austin, TX (US); Maunish Shah, Austin, TX (US); Douglas Roy Kaiser, Pflugerville, TX (US)

(21) Appl. No.: 18/656,818

(22) Filed: May 7, 2024

(51) Int. Cl. H01R 43/26; H01R 9/05; H01R 13/622; H01R 13/629; H01R 24/40; H01R 103/00

(52) U.S. Cl. CPC H01R 43/26; H01R 9/05; H01R 13/622; H01R 13/629; H01R 24/40; H01R 2103/00; H01R 2201/04

(57) ABSTRACT

A meshed gear cable connector fastening system includes a cable. A cable connector is rotatably coupled to the cable and includes connector gear teeth. A key hole base is mounted to the cable adjacent the cable connector such that the key hole base does not rotate independently of the cable. The key hole based defines a key hole that is configured to receive a geared fastener device to mesh fastener gear teeth on a geared fastener device with the connector gear teeth on the cable connector. Rotation of the fastener gear teeth relative to the key hole base to rotate the cable connector via the connector gear teeth meshed with the fastener gear teeth.

### BACKGROUND

The present disclosure relates generally to information handling systems, and more particularly to facilitating the fastening and/or unfastening of a cable connector with an information handling system.

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems such as networking devices, server devices, and/or other computing devices known in the art may utilize cabling systems to transmit data between computing devices in a networked system, provide connectivity to the Internet, and/or provide other communication needs between computing devices. Conventional cabling systems include a cable connector that connects a cable to a computing device connector on the computing device. For example, some cabling systems include a cable connector (e.g., SubMiniature version A connectors (SMA), semi-precision coaxial RF connectors, etc.) with a cable connector fastener that includes a “hex” nut grip on the base of the cable connector, while other cabling systems include a cable connector (e.g., N-connectors/type-N connectors, medium-size RF connectors used to join coaxial cables, etc.) provided with a cable connector fastener that includes a grip without a “hex” nut on the base of the cable connector, and either cable connector fastener may be rotated by hand in order to fasten and unfasten the cable connector to and from the computing device connector on the computing device. However, such conventional cabling systems raise some issues.

As will be appreciated by one of skill in the art in possession of the present disclosure, networking hardware customers are requiring relatively higher density devices, lower latency, higher reliability, and high data transmission rates than were possible with previously available hardware. For example, network infrastructure providers, in accommodating the move to 5G, have designed hardware/cards with dense configurations of computing device connectors (e.g., the INTEL® WestPort Channel (WPC) Network Interface Controller (NIC) with Global Navigation Satellite System (GNSS) module available from INTEL® Corp. of Santa Clara, California, United States, which includes four Small Form-factor Pluggable 28 (SFP28) ports, a GNSS receiver port and dual SMA ports) for computing devices to satisfy this demand. However, these dense configurations of computing device connectors can present issues with regard to the fastening and unfastening of cable connectors to those computing device connectors, as computing device chassis features, cabling systems connected to the computing device, and/or other obstructions on the computing device may restrict the hand/finger access required to access cable connector fasteners in order to fasten or unfasten cable connectors to and from computing device connectors.

For example, due to the design of products like the INTEL® WPC NIC discussed above, issues can arise with features like chassis air dams (e.g., recesses in the chassis in which the computing device connectors are located) that further exacerbate the lack of finger access introduced by the dense computing device connector/cable placement and can make the connection and disconnection of cable connector on cables with computing device connectors even more difficult. Such cable connectors are designed to be hand-tightened, but insufficient space between computing device connectors combined with limited clearance (e.g., on the top and bottom of the chassis introduced by the air dam) make it difficult to access and rotate the cable connector fasteners on the cable connectors by hand. Conventional solutions to these issues include the use of “snap-in” cable connectors (e.g., SubMiniature version B (SMB) connectors) that require only that the cable connector fastener on the cable connector be pushed into a computing device connector, or pulled out of a computing device connector, in order to fasten and unfasten the cable connector to and from the computing device connector. However, such cable connectors can be inadvertently disconnected from their computing device connector in response to, for example, tension on their cable.

Accordingly, it would be desirable to provide a cable connector fastener system that addresses the issues discussed above.

### SUMMARY

According to one embodiment, an Information Handling System (IHS) includes a chassis; a processing system that is housed in the chassis; a memory system that is housed in the chassis, that is coupled to the processing system, and that includes instructions that, when executed by the processing system, cause the processing system to provide a processing engine that is configured to perform processing functionality; an IHS connector that is accessible on the chassis and that is coupled to the processing system; and a meshed gear cable connector fastening system, including: a cable, a cable connector that is rotatably coupled to the cable, that includes connector gear teeth, and that is connected to the IHS connector; and a key hole base that defines a key hole and that is mounted to the cable adjacent the cable connector such that the key hole base does not rotate independently of the cable, wherein the key hole is configured to: receive a geared fastener device to mesh fastener gear teeth on a geared fastener device with the connector gear teeth on the cable connector, and allow rotation of the fastener gear teeth relative to the key hole base to rotate the cable connector via the connector gear teeth meshed with the fastener gear teeth.

### BRIEF DESCRIPTION OF THE DRAWINGS

FIG. 1 is a schematic view illustrating an embodiment of an Information Handling System (IHS).

FIG. 2 is a schematic view illustrating an embodiment of a networking device that may be used with the meshed gear cable connector fastener extension system of the present disclosure.

FIG. 3 is a schematic top view illustrating an embodiment of a communication device that may be included in the networking device of FIG. 2.

FIG. 4 is a perspective view illustrating an embodiment of a geared fastening device that may be included in the meshed gear cable connector fastening system of the present disclosure.

FIG. 5A is a perspective view illustrating an embodiment of a geared fastening device that may be included in the meshed gear cable connector fastening system of the present disclosure.

FIG. 5B is a perspective view illustrating an embodiment of a geared fastening device of FIG. 5A.

FIG. 6A is a perspective view illustrating an embodiment of a geared fastening device that may be included in the meshed gear cable connector fastening system of the present disclosure.

FIG. 6B is a perspective view illustrating an embodiment of the geared fastening device of FIG. 6A.

FIG. 7 is a perspective view illustrating an embodiment of a cabling system with a geared cable connector that may be included in the meshed gear cable connector fastening system of the present disclosure.

FIG. 8 is a flow chart illustrating an embodiment of a method for meshed gear fastening a cabling system to a computing device.

FIG. 9 is a perspective view illustrating an embodiment of conventional cabling systems connected to a computing device.

FIG. 10A is a schematic top view illustrating an embodiment of the cabling system of FIG. 7 being engaged with a computing device connector on the communication system of FIG. 3 during the method of FIG. 8.

FIG. 10B is a perspective view illustrating an embodiment of the cabling system of FIG. 7 being engaged with the computing device connector of FIG. 10A during the method of FIG. 8.

FIG. 11A is a schematic top view illustrating an embodiment of the cabling system of FIG. 7 engaged with the computing device connector on the communication system of FIG. 3 during the method of FIG. 8.

FIG. 11B is a perspective view illustrating an embodiment of the cabling system of FIG. 7 engaged with the computing device connector on the communication system of FIG. 3 during the method of FIG. 8.

FIG. 12A is a perspective view illustrating an embodiment of the geared fastening device of FIG. 4 being coupled to the cabling system engaged with the computing device connector on the communication system of FIG. 11B during the method of FIG. 8.

FIG. 12B is a perspective view illustrating an embodiment of the geared fastening device of FIG. 4 coupled to the cabling system engaged with the computing device connector on the communication system of FIG. 11B during the method of FIG. 8.

FIG. 12C is a perspective view illustrating an embodiment of the geared fastening device of FIG. 4 fastening the cabling system to the computing device connector on the communication system of FIG. 11B during the method of FIG. 8.

FIG. 13 is a schematic top view illustrating an embodiment of the cabling system of FIG. 7 fastened to the computing device connector on the communication system of FIG. 3 during the method of FIG. 8.

FIG. 14 is a perspective view illustrating an embodiment of the geared fastening device of FIG. 4 unfastening the cabling system from the computing device connector on the communication system of FIG. 13 during the method of FIG. 8.

### DETAILED DESCRIPTION

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), server (e.g., blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

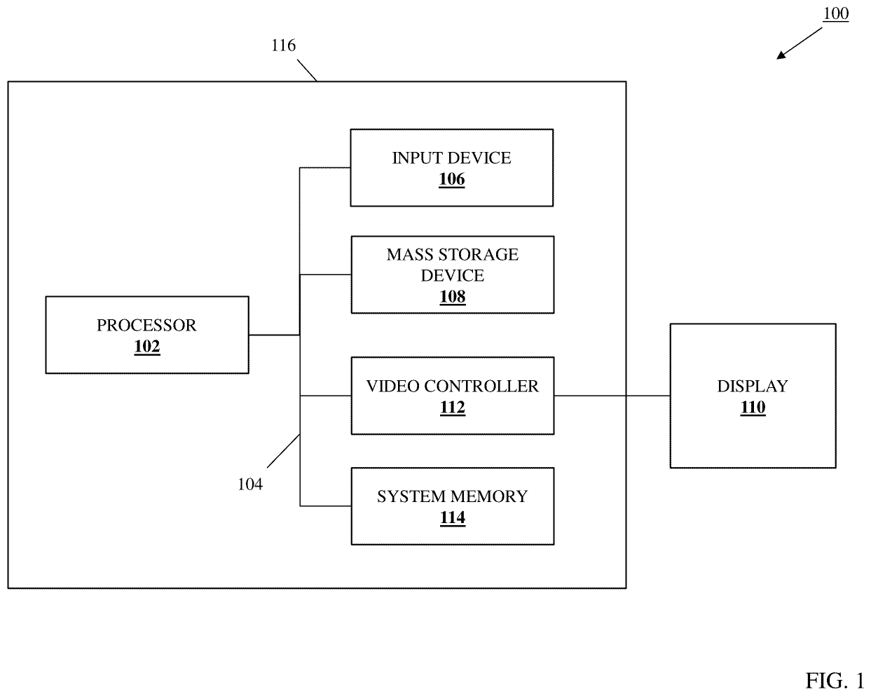

In one embodiment, IHS 100, FIG. 1, includes a processor 102, which is connected to a bus 104. Bus 104 serves as a connection between processor 102 and other components of IHS 100. An input device 106 is coupled to processor 102 to provide input to processor 102. Examples of input devices may include keyboards, touchscreens, pointing devices such as mouses, trackballs, and trackpads, and/or a variety of other input devices known in the art. Programs and data are stored on a mass storage device 108, which is coupled to processor 102. Examples of mass storage devices may include hard discs, optical disks, magneto-optical discs, solid-state storage devices, and/or a variety of other mass storage devices known in the art. IHS 100 further includes a display 110, which is coupled to processor 102 by a video controller 112. A system memory 114 is coupled to processor 102 to provide the processor with fast storage to facilitate execution of computer programs by processor 102. Examples of system memory may include random access memory (RAM) devices such as dynamic RAM (DRAM), synchronous DRAM (SDRAM), solid state memory devices, and/or a variety of other memory devices known in the art. In an embodiment, a chassis 116 houses some or all of the components of IHS 100. It should be understood that other buses and intermediate circuits can be deployed between the components described above and processor 102 to facilitate interconnection between the components and the processor 102.

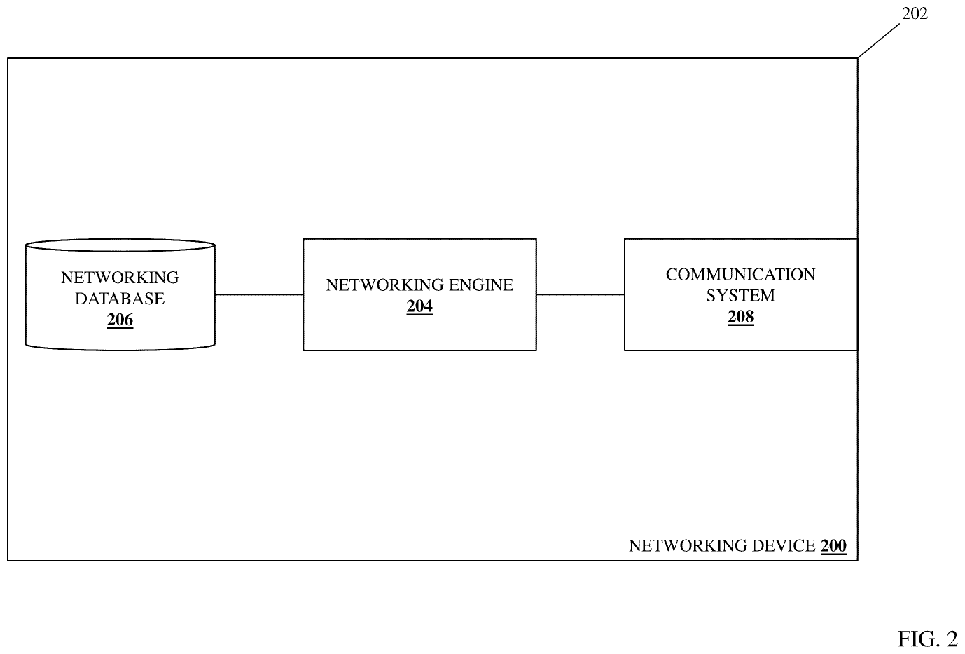

Referring now to FIG. 2, an embodiment of a networking device 200 is illustrated that may be used with the meshed gear cable connector fastening system of the present disclosure. In the illustrated embodiment, the networking device 200 may be provided by the IHS 100 discussed above with reference to FIG. 1, and/or may include some or all of the components of the IHS 100, and in specific examples may be provided by a switch device, a router device, and/or other networking devices known in the art. However, while illustrated and discussed as being provided by a networking device, one of skill in the art in possession of the present disclosure will appreciate that the functionality of the networking device 200 discussed below may be provided by other devices (e.g., server devices and/or other computing devices known in the art) that are configured to operate similarly as the networking device 200 discussed below. In the illustrated embodiment, the networking device 200 includes a chassis 202 that houses the components of the networking device 200, only some of which are illustrated and discussed below.

For example, the chassis 202 may house a processing system (not illustrated, but which may include the processor 102 discussed above with reference to FIG. 1) and a memory system (not illustrated, but which may include the memory 114 discussed above with reference to FIG. 1) that is coupled to the processing system and that includes instructions that, when executed by the processing system, cause the processing system to provide a networking engine 204 that is configured to transmit data via the cabling systems described below, and/or perform other functionality of networking engines and/or networking devices that would be apparent to one of skill in the art in possession of the present disclosure.

The chassis 202 may also house a storage system (not illustrated, but which may include the storage device 108 discussed above with reference to FIG. 1) that is coupled to the networking engine 204 (e.g., via a coupling between the storage system and the processing system) and that includes a networking database 206 that is configured to store any of the information utilized by the networking engine 204. The chassis 202 may also house a communication system 208 that is coupled to the networking engine 204 (e.g., via a coupling between the communication system and the processing system) and that may be provided by a Network Interface Controller (NIC) (e.g., the INTEL® WPC NIC discussed above) and/or any of a variety of other networking communication components that would be apparent to one of skill in the art in possession of the present disclosure. As discussed below, the communication system 208 may include networking device connectors and/or other computing device connectors that are configured to connect to cabling systems that include the meshed gear cable connector fastening system of the present disclosure. However, while a specific networking device 200 has been illustrated and described, one of skill in the art in possession of the present disclosure will appreciate that networking devices (and other devices that utilize the cabling systems of the present disclosure) may include different components and/or component configurations while remaining within the scope of the present disclosure as well.

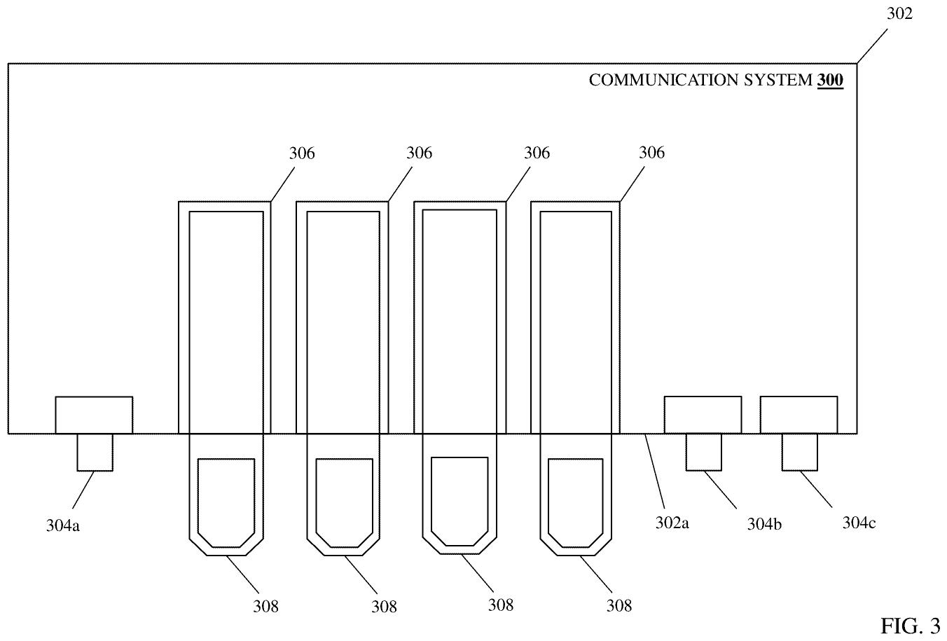

Referring now to FIG. 3, an embodiment of a communication system 300 is illustrated that may provide the communication system 208 discussed above with reference to FIG. 2. In the illustrated embodiment, the communication system 300 includes a chassis 302 that includes the components of the communication system 300, only some of which are illustrated and discussed below. For example, the chassis 302 includes an outer surface 302a, with a plurality of computing device connectors 304a, 304b, and 304c extending from the outer surface 302a and configured to connect to a cabling system that includes the meshed gear cable connector fastening system of the present disclosure in order to allow data to be transmitted between a networking device (e.g., the networking device 200) and other computing devices. However, while illustrated and described as being used with computing device connectors on a networking device, one of skill in the art in possession of the present disclosure will appreciate how the meshed gear cable connector fastening system of the present disclosure may be used with any other computing device connectors on any other computing devices while remaining within the scope of the present disclosure as well.

In some embodiments, and as illustrated and described below, the communication system 300 of FIG. 3 may include additional computing device connectors placed in close proximity to (e.g., above and/or below) the computing device connectors 304a-304c. As discussed above, computing device connectors provided in close proximity to one another can restrict hand and finger access to cable connectors that connect to those computing device connectors, particularly when cabling system are connected. However, while a specific example of computing device connectors that introduce restricted access to cable connectors has been described, one of skill in the art in possession of the present disclosure will appreciate how access to cable connectors that connect to computing device connectors may be restricted in a variety of manners while remaining within the scope of the present disclosure as well.

For example, multiple communication systems similar to the communication system 300 (e.g., the INTEL® WPC NIC discussed above) may be positioned in close proximity to one another in an individual server device. In a specific example, a server device (e.g., the DELL® EMC Power Edge XR11, available from DELL® computers of Round Rock, Texas, United States) may be configured to have two or more communication systems installed on two or more available Peripheral Component Interconnect express (PCIe) slots and mounted in the server device in close proximity to one another. As would be appreciated by one of skill in the art in possession of the present disclosure, the placement of two or more communication systems in close proximity to one another operates to further restrict hand and finger access to cable connectors that connect to computing device connectors on those communication systems.

In yet another example, a plurality of server devices may be positioned in a rack system (e.g., in a datacenter) in close proximity to one another. In a specific example, a standard 42 Rack Unit (42U) rack can accommodate up to 42 servers that are each 1 Rack Unit (1U), and one of skill in the art in possession of the present disclosure will appreciate how positioning multiple server devices in close proximity to one another (e.g., with each server device including multiple computing device connectors and multiple communication systems) operate to further restrict hand and finger access to cable connectors that connect to their computing device connectors. As such, a wide variety of computing device connector configurations, chassis configurations, and/or other factors that operate to restrict hand and finger access to cable connectors are envisioned as falling within the scope of the present disclosure.

In the illustrated embodiment, the chassis 302 also includes a plurality of transceiver device ports 306 that are positioned between the computing device connectors 304a and 304b and that are configured to receive transceiver devices 308 in order to allow data to be transmitted between a networking device (e.g., the networking device 208) and other computing devices, and one of skill in the art in possession of the present disclosure will appreciate how the transceiver device ports 306 or their connected transceiver devices 308 may operate to further restrict hand and finger access to the cable connectors that connect to computing device connectors 304a-304c on the communication system 300. However, while a specific example of a communication system 300 has been illustrated and described, one of skill in the art in possession of the present disclosure will appreciate how communication systems may include other connectors and/or connector configurations while remaining within the scope of the present disclosure.

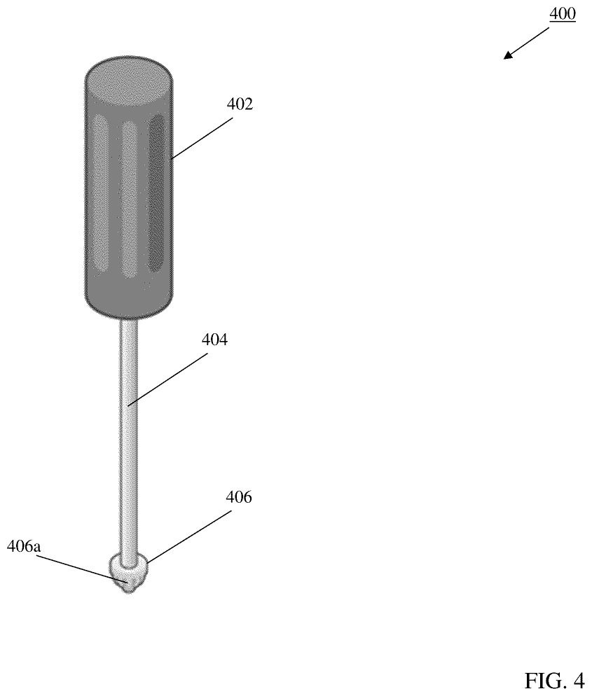

Referring now to FIG. 4, an embodiment of a geared fastening device 400 is illustrated that may be included in the meshed gear cable connector fastening system provided according to the teachings of the present disclosure. In the illustrated embodiment, the geared fastening device 400 includes a geared fastening device handle 402 that includes a textured surface that is configured to be gripped by a user. The geared fastening device 400 also includes a geared fastening device shaft 404 that extends from the geared fastening device handle 402. While a specific length geared fastening device shaft 404 is illustrated and described herein, the geared fastening device shaft 404 included on the geared fastening device 400 may be provided with varying lengths that are shorter or longer than illustrated in FIG. 4, and that one of skill in the art in possession of the present disclosure will appreciate may operate in meshed gear cable connector fastening systems to couple cables to computing device connectors at varying distances. In the embodiments illustrated and described below, the geared fastening device shaft 404 is a solid, rigid shaft of a fixed length. However, in other embodiments, the geared fastening device shaft 404 may be flexible and/or otherwise moveable, which one of skill in the art in possession of the present disclosure will appreciate may allow the geared fastening device shaft 404 to move around obstacles. However, while specific examples of geared fastening device shafts have been discussed, one of skill in the art in possession of the present disclosure will appreciate how the geared fastening device may include other types of geared fastening device shafts while remaining within the scope of the present disclosure as well.

The geared fastening device 400 also provides a geared tip 406 that is located on an end of the geared fastening device shaft 404 opposite the geared fastening device handle 402, and that includes a plurality of fastener gear teeth 406a about its perimeter. In the illustrated embodiment, the fastener gear teeth 406a on the geared fastening device 400 provide a beveled gear, but one of skill in the art in possession of the present disclosure will appreciate how the gear provided by the fastener gear teeth 406a on the geared fastening device 400 may include a variety of gear types/gear systems that one of skill in the art in possession of the present disclosure will appreciate may operate in the meshed gear cable connector fastening system to couple geared cable connectors to computing device connectors similarly as described below while remaining within the scope of the present disclosure. In the specific example provided in FIG. 4, the geared fastening device 400 includes an integrated geared tip 406, but one of skill in the art in possession of the present disclosure will appreciate how other configurations of the geared tip on the geared fastening device shaft will fall within the scope of the present disclosure as well.

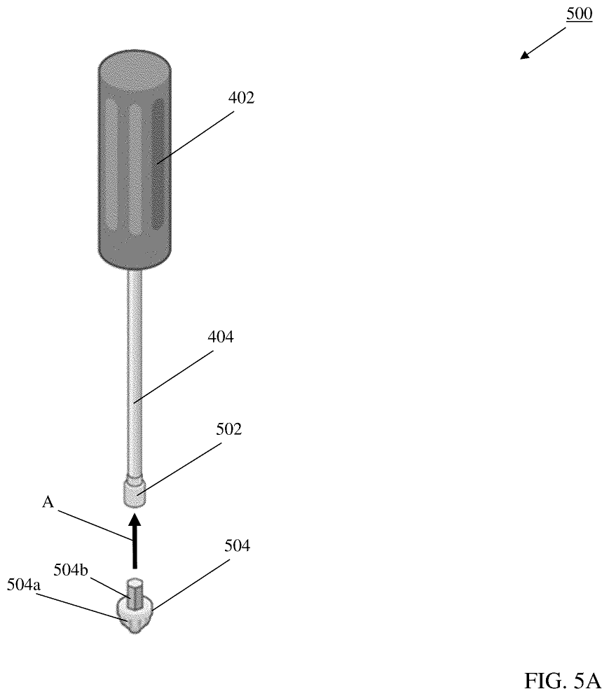

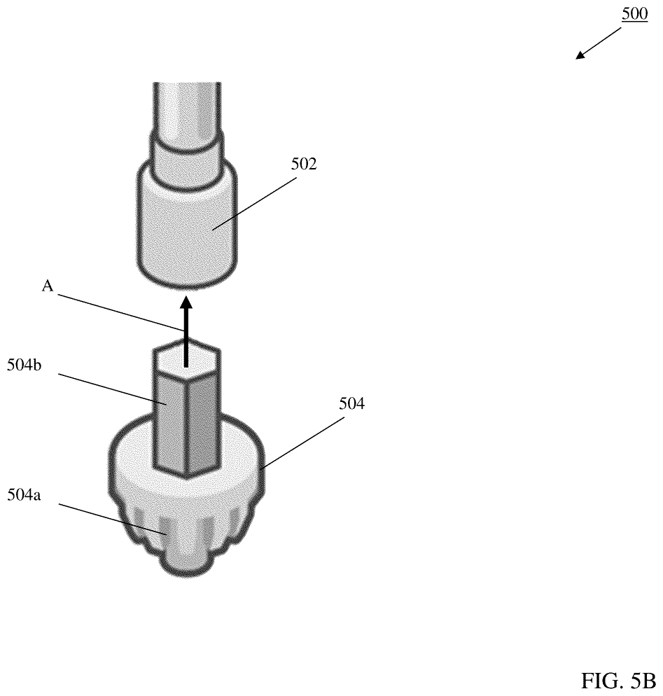

For example, referring now to FIGS. 5A and 5B, an embodiment of a geared fastening device 500 is illustrated that is similar to the geared fastening device 400 discussed above with reference to FIG. 4, and thus similar elements have been provided with the same element numbers. However, in the embodiment illustrated in FIGS. 5A and 5B, the integrated geared tip 406 has been removed, and the geared fastening device shaft 404 is provided with a female socket 502 that is included on an end of the geared fastening device shaft 404 opposite the geared fastening device handle 402. Furthermore, a geared bit 504 that includes a plurality of fastener gear teeth 504a about its perimeter is provided for use with the geared fastening device 500, and includes a male socket member 504b that one of skill in the art in possession of the present disclosure will appreciate is configured to couple with the female socket 502 on the geared fastening device shaft 404 when the geared bit 504 is moved in the direction A illustrated in FIG. 5A. As will be appreciated by one of skill in the art in possession of the present disclosure, a plurality geared bits that are similar to the geared bit 504 but that have different sizes, fastener gear teeth, and/or other geared bit features may be provided for use in the geared fastener device 500 in order to allow the functionality described below with a variety of different cable connectors.

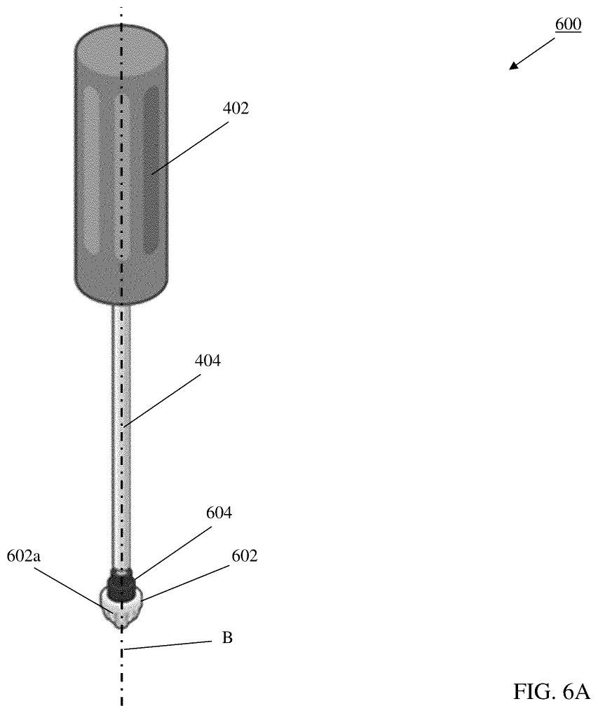

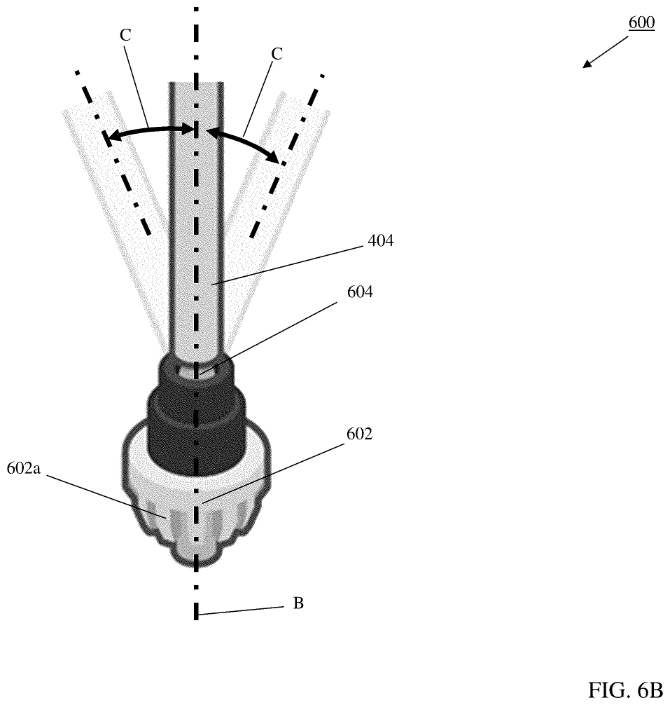

Referring now to FIGS. 6A and 6B, in another example, a geared fastening device 600 is illustrated that is similar to the geared fastening device 400 discussed above with reference to FIG. 4, and thus similar elements have been provided with the same element numbers. However, in the embodiment illustrated in FIGS. 6A and 6B, the integrated geared tip 406 has been removed, and the geared fastening device shaft 404 is provided with a geared tip 602 that includes a plurality of fastener gear teeth 602a about its perimeter, and that is pivotally attached to an end of the geared fastening device shaft 404 opposite the geared fastening device handle 402 by a pivotal coupling 604.

In the specific example illustrated in FIGS. 6A and 6B, the geared fastening device 600 includes an axis B that is centrally located on the geared fastening device handle 402 and the geared fastening device shaft 404. As can be seen in FIG. 6B, the geared fastening device shaft 404 is configured to move relative to the geared tip 602 and through an angle C via the pivotal coupling 604, and one of skill in the art in possession of the present disclosure will appreciate how that movement of the geared fastening device shaft 404 relative to the geared tip 602 may be performed 360 degrees around the axis B. In the specific example of FIGS. 6A and 6B, the pivotal coupling 604 is integrated on an end of the geared fastening device shaft 602b, but one of skill in the art in possession of the present disclosure will appreciate how the pivotal coupling 604 may be coupled to the geared fastening device shaft 404 in a variety of manners (e.g., a pivotal coupling may be provided on an attachable geared bit similarly as described above with reference to FIGS. 5A and 5B) while remaining within the scope of the present disclosure as well.

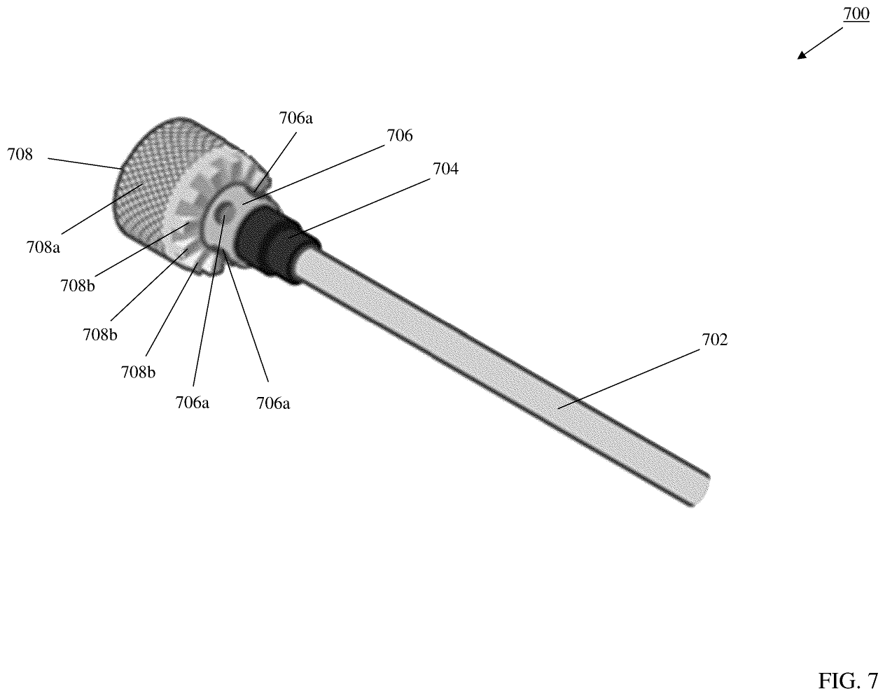

Referring now to FIG. 7, an embodiment of a cabling system 700 is illustrated that may be included in the meshed gear cable connector fastening system provided according to the teaching of the present disclosure. In the illustrated embodiment, the cabling system 700 includes a cable 702 having a strain relief element 704 that is included on one end of the cable 702. In an embodiment, the cable 702 may be provided by a coaxial cable, although one of skill in the art in possession of the present disclosure will appreciate how other types of cables may be utilized in the meshed gear cable connector fastening system of the present disclosure while remaining within its scope as well.

The cabling system 700 also includes a key hole base 706 that is mounted to the cable and/or the strain relief element 704 such that the key hole base does not rotate independently of the cable 702. As can be seen in the illustrated example, the key hole base 706 defines a plurality of key holes 706a that are spaced apart from each other about the circumference of the key hole base 706. However, while a specific configuration of a plurality of key holes has been illustrated and described, one of skill in the art in possession of the present disclosure will appreciate how a variety of key hole spacing and/or configurations (including a single key hole) may be utilized while remaining within the scope of the present disclosure.

The cabling system 700 also includes a geared cable connector 708 that is moveably coupled to the key hole base 706 and the cable 702. The geared cable connector 708 includes a knurled surface 708a that extends around the circumference of the geared cable connector 708 and that is configured to be gripped by a user (i.e., in situations where there is sufficient space for finger access to the geared cable connector 708). The geared cable connector 708 also defines a plurality of connector gear teeth 708b that extend around the circumference of the geared cable connector 708 and that are located adjacent the key hole base 706. In the specific example illustrated and described below, the connector gear teeth 708b on the geared cable connector 708 provide a beveled gear, but one of skill in the art in possession of the present disclosure will appreciate how the gear provided by the geared cable connector 708 may include a variety of gear types/gear systems that one of skill in the art in possession of the present disclosure will appreciate may operate in the meshed gear cable connector fastening system to couple geared cable connectors to computing device connectors as described below while remaining within the scope of the present disclosure. While not illustrated or described in detail, one of skill in the art in possession of the present disclosure will appreciate how the cable 702 may include an end that is located opposite the end that is visible in the FIG. 7 and that includes features similar to those illustrated and described above. However, while a specific cabling system has been illustrated and described, one of skill in the art in possession of the present disclosure will appreciate that cabling systems provided according to the teachings of the present disclosure may include a variety of components and/or configurations within the scope of the present disclosure.

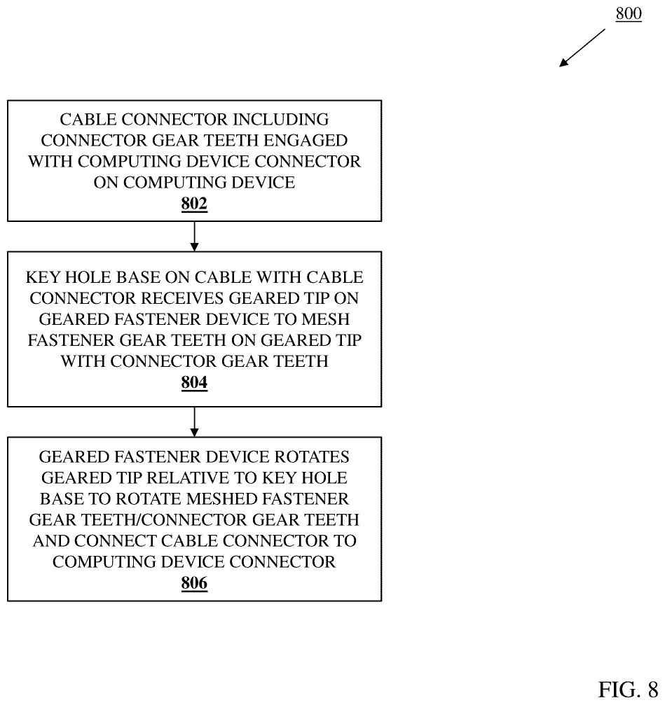

Referring now to FIG. 8, an embodiment of a method 800 for meshed gear fastening a cable connector to a computing device is illustrated. As discussed below, the systems and methods of the present disclosure provide for the fastening and/or unfastening of a cable connector and a computing device connector utilizing meshed gears. For example, the meshed gear cable connector fastening system of the present disclosure may include a cable. A cable connector is rotatably coupled to the cable and includes connector gear teeth. A key hole base is mounted to the cable adjacent the cable connector such that the key hole base does not rotate independently of the cable. The key hole based defines a key hole that is configured to receive a geared fastener device to mesh fastener gear teeth on a geared fastener device with the connector gear teeth on the cable connector. Rotation of the fastener gear teeth relative to the key hole base to rotate the cable connector via the connector gear teeth meshed with the fastener gear teeth. As such, the fastening (or the unfastening) of a cable connector and a computing device connector is facilitated when, for example, obstructions restrict hand/finger access to the cable connector.

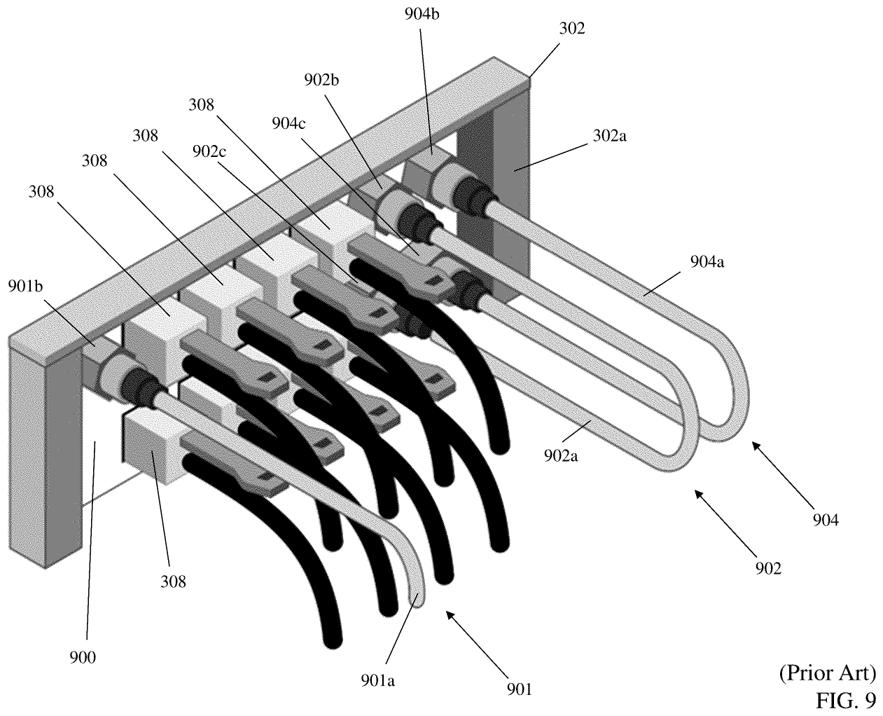

With reference to FIG. 9 (and reference back to FIG. 3), an embodiment of the communication system 300 of FIG. 3 is illustrated with conventional cabling systems connected to the computing device connectors 304a, 304b, and 304c. FIG. 9 illustrates an example of a vertical connector stack of the computing device connectors 304a, 304b, and 304c and transceiver device connectors 306/transceiver devices 308 on the chassis 302 of the communication system 300, with two rows of the computing device connectors 304a-304c/transceiver device connectors 306/transceiver devices 308 vertically stacked to provide a “top” row of connectors and a “bottom” row of connectors. Furthermore, in the example illustrated in FIG. 9, a recessed portion 900 is defined on the outer surface 302a of the chassis 302 with the vertical connector stack of the computing device connectors 304a, 304b, and 304c and transceiver device connectors 306/transceiver devices 308 located in the recessed portion 900. In the illustrated embodiment, a first conventional cabling system 901 includes a cable 901a and a cable connector 901b that has been fastened to the computing device connector 304a (not visible in FIG. 9) in the “top” row of the vertical connector stack. Similarly, a second conventional cabling system 902 includes a cable 902a, a cable connector 902b that has been fastened to the computing device connector 304b (not visible in FIG. 9) in the “top” row of the vertical connector stack, and a cable connector 902c that has been fastened to the computing device connector 304b (not visible in FIG. 9) in the “bottom” row of the vertical connector stack.

Similarly, a third conventional cabling system 904 includes a cable 904a, a cable connector 904b that has been fastened to the computing device connector 304c (not visible in FIG. 9) in the “top” row of the vertical connector stack, and a cable connector 904c that has been fastened to the computing device connector 304c (not visible in FIG. 9) in the “bottom” row of the vertical connector stack. As discussed above, and as will be appreciated by one of skill in the art in possession of the present disclosure, the dense configuration of cabling systems 901-904 and transceiver devices 308 on the chassis 302 in FIG. 9 may restrict hand/finger access to the cable connectors that is necessary to allow for the fastening and unfastening those cable connectors with their corresponding computing device connectors 304a-304c, and such issues are further exacerbated by the positioning of the vertical connector stack and connected cabling systems in the recessed portion 900 of the chassis 302. However, while a specific conventional cabling system/computing device connector configuration has been illustrated and described, one of skill in the art in possession of the present disclosure will appreciate that a variety of other conventional cabling system/computing device connector configurations will benefit from the connector fastener extension system of the present disclosure and thus will fall within its scope.

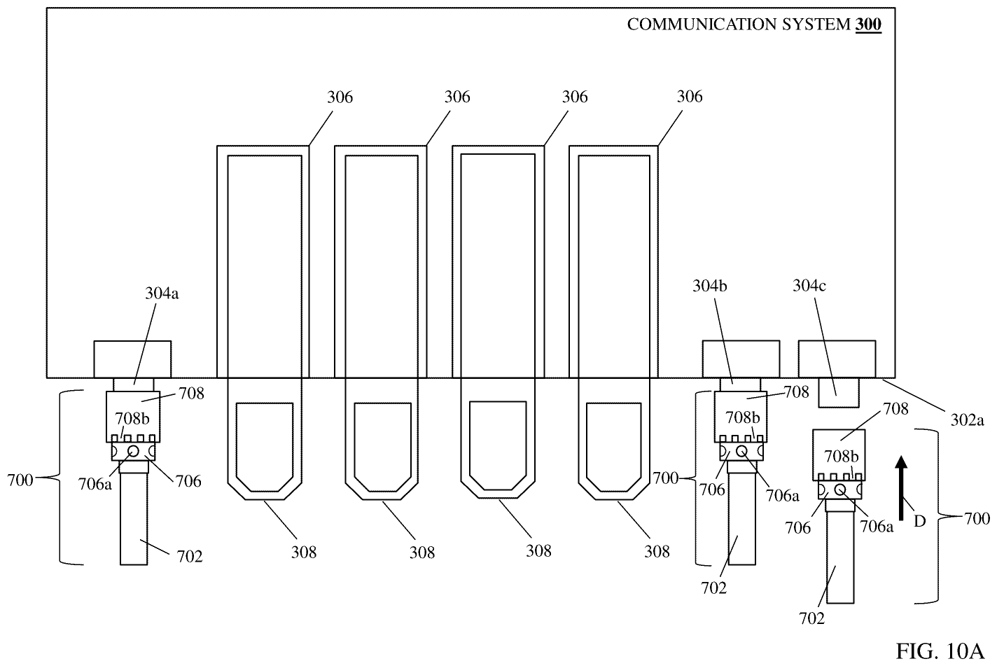

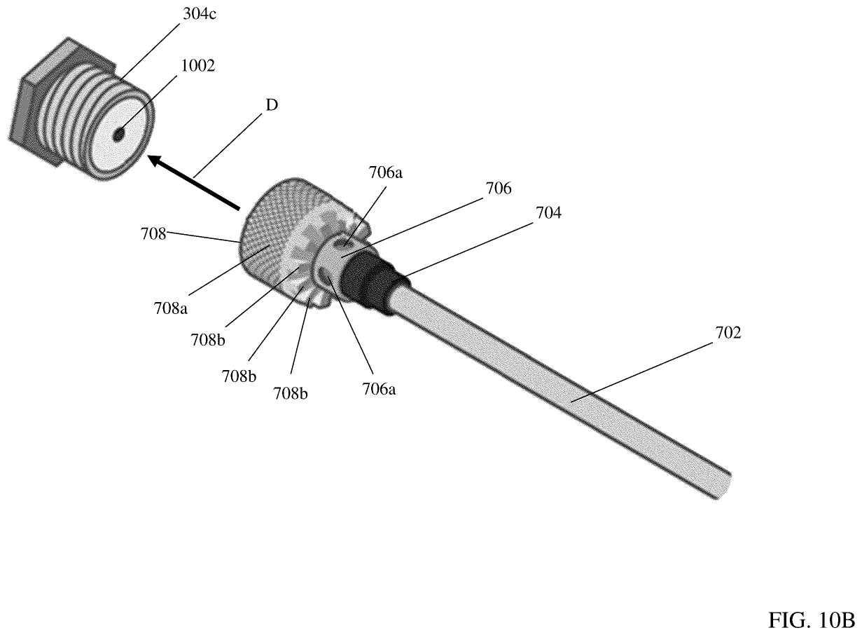

The method 800 begins at block 802 where a cable connector including connector gear teeth is engaged with a computing device connector on a computing device. With reference to FIGS. 10A and 10B, in an embodiment of block 402, the cabling systems 700 discussed above with reference to FIG. 7 may be positioned adjacent the computing device connector 304c on the communications system 300 such that the geared cable connector 708 is located adjacent and aligned with the computing device connector 304c. The geared cable connector 708 on the cabling system 700 may then be moved in a direction D toward the computing device connector 304c.

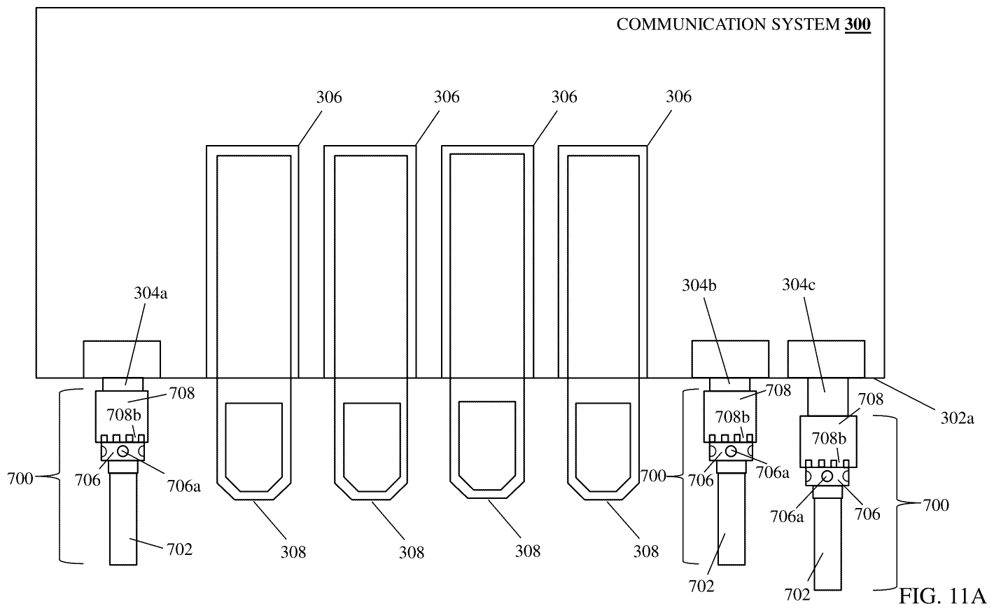

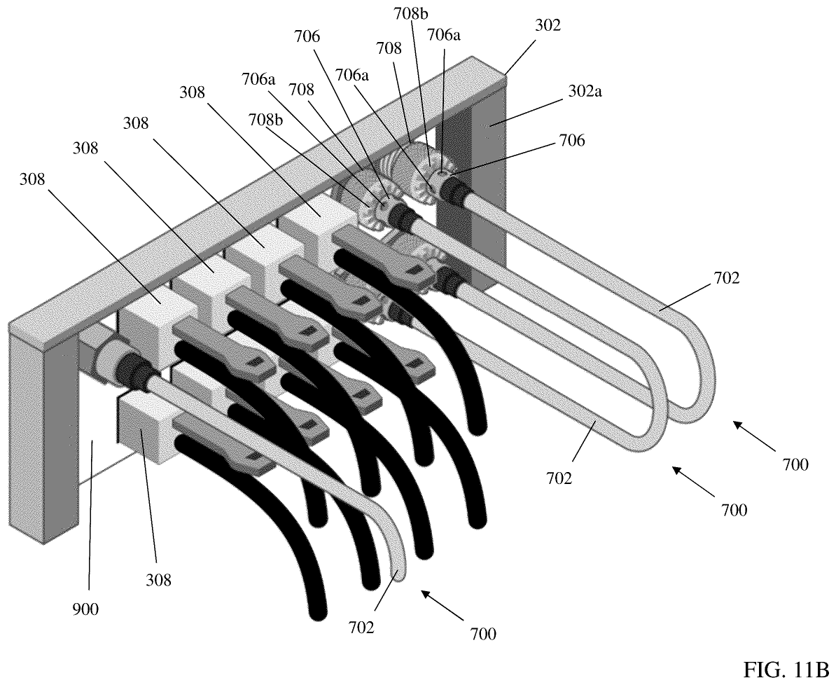

With reference to FIGS. 11A and 11B, and as will be appreciated by one of skill in the art in possession of the present disclosure, the geared cable connector 708 may include a pin (e.g., a coaxial cable pin, not visible in FIG. 10A, 10B, 11A or 11B) that may engage a pin receiver 1002 (visible in FIG. 10B) included on the computing device connector 304c in response to movement of the geared cable connector 708 in the direction D, which may cause the geared cable connector 708 to be held in place in engagement with the computing device connector 304c. However, while a specific example of the engagement of a cable connector and a computing device connector has been described, one of skill in the art in possession of the present disclosure will appreciate how the cabling system 700 may be engaged with a computing device connector in a variety of manners that will fall within the scope of the present disclosure as well. Furthermore, while not illustrated or described in detail, one of skill in the art in possession of the present disclosure will appreciate how the cabling systems illustrated in the figures may be coupled to the computing device connectors on the computing device in a similar manner as described herein for the computing device connector 304c.

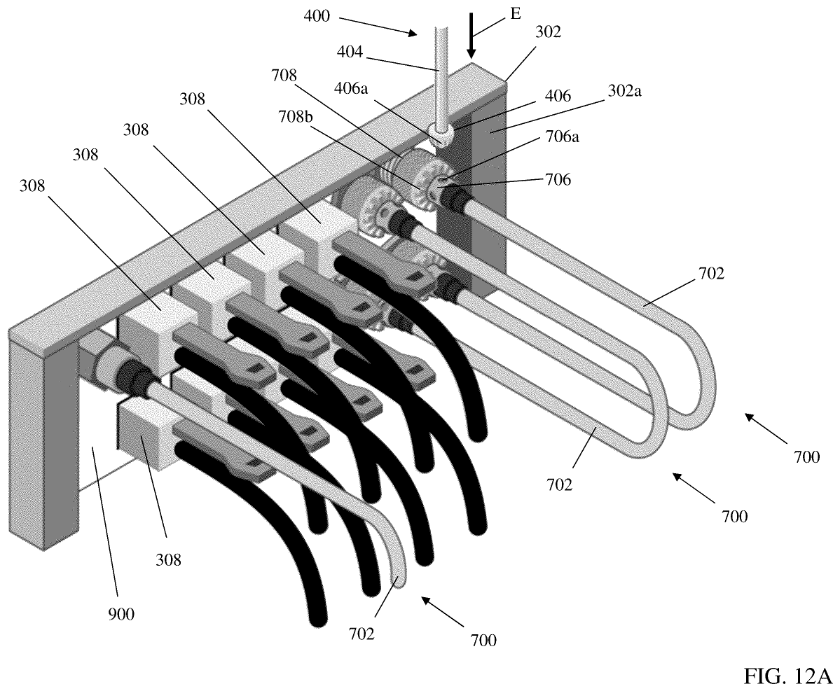

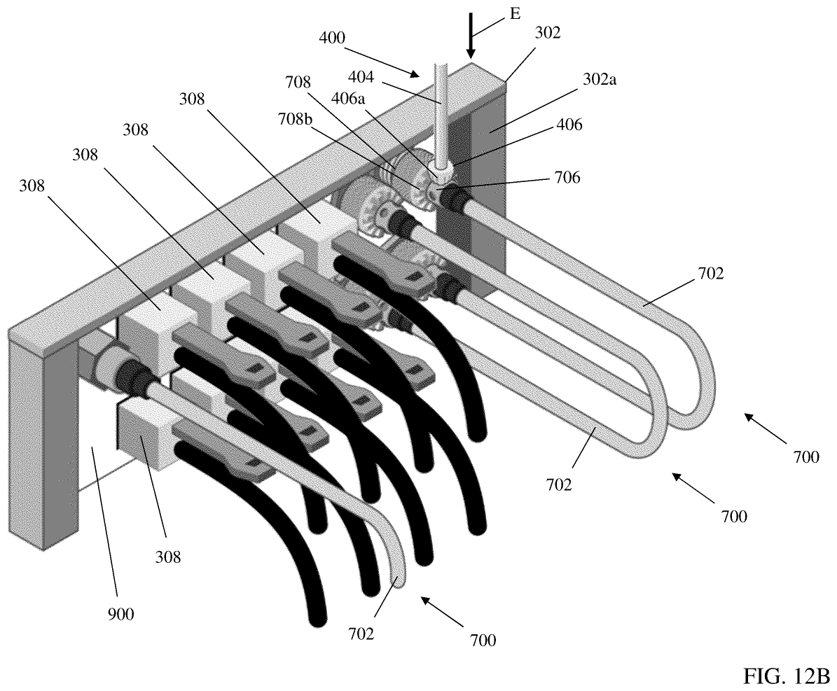

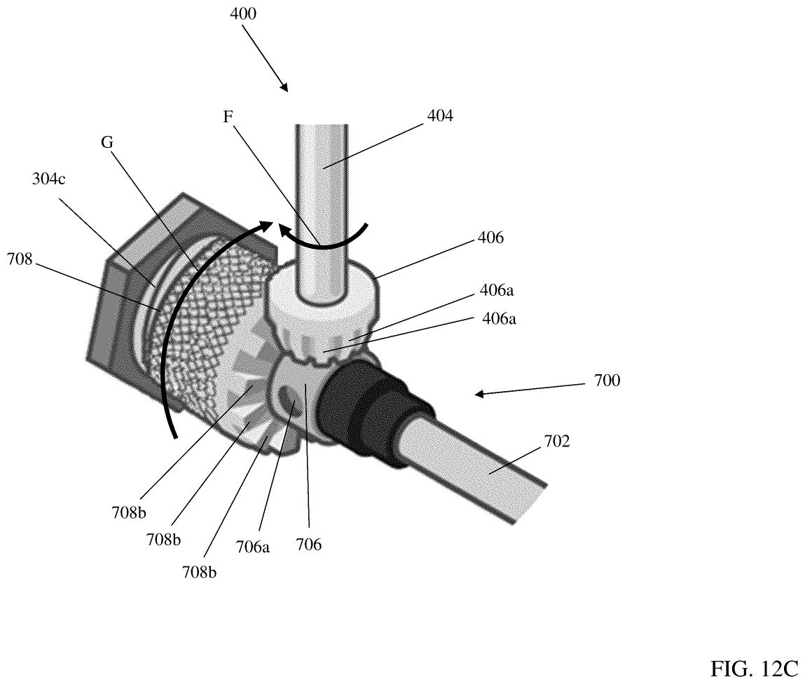

The method 800 then proceeds to block 804 where a key hole base on a cable with the cable connector receives a geared tip on a geared fastener device to mesh fastener gear teeth on the geared tip with the connector gear teeth. With reference to FIG. 12A, a geared fastener device 400 may be positioned adjacent the geared cable connector 708 that was engaged with the computing device connector 304c at block 804 such that the geared tip 406 on the geared fastener device 400 is located adjacent and aligned with a key hole 706a defined by the key hole base 706 on the cabling system 700. With reference to FIGS. 12A and 12B, the geared fastening device 400 may then be moved in a direction E such that the geared tip 406 on the geared fastener device 400 is received by the key hole 706a defined by the key hole base 706. As will be appreciated by one of skill in the art in possession of the present disclosure, the positioning of the geared tip 406 on the geared fastener device 400 in the key hole 706a defined by the key hole base 706 will cause the fastener gear teeth 406a on the geared tip 406 to mesh with the connector gear teeth 708b on the geared cable connector 708 (e.g., due to the ability of the geared cable connector 708 to rotate relative to the key hole base 706).

As will be appreciated be one of skill in the art in possession of the present disclosure, limited hand/finger access to computing device connectors, or cable connectors connected to computing device connectors, may prevent a user from rotating conventional cable connectors relative to computing device connectors in order to fasten or unfasten them. However, as can be seen in FIGS. 12A and 12B and as described in further detail below, the engagement of the geared tip 406 on the geared fastening device 400 with the key hole 706a and the corresponding meshing of the fastener gear teeth 406a on the geared tip 406 with the connector gear teeth 708b on the geared cable connector 708 enables the rotation of the geared cable connector 708 of the present disclosure relative to the computing device connector 304c to fasten or unfasten them when the lack of hand/finger access would otherwise prevent a user from doing so. Furthermore, while the engaging of the geared tip 406 on the geared fastening device 400 with the geared cable connector 708 has been described, one of skill in the art in possession of the present disclosure will appreciate how the geared fastening devices 500 and 600 discussed above with reference to FIGS. 5A and 6A may be engaged with the geared cable connector 708 in a similar manner.

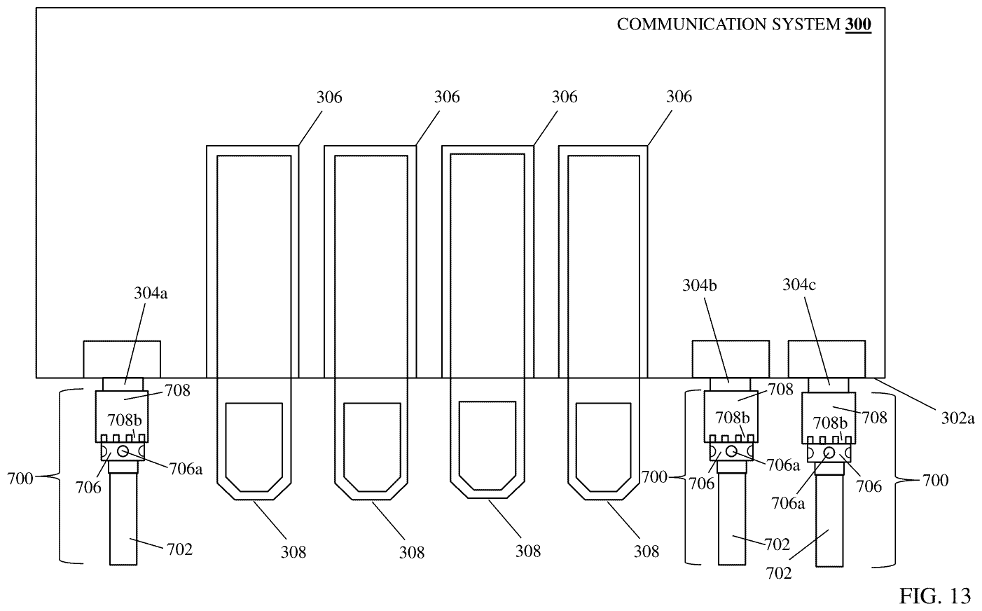

The method 800 then proceeds to block 806 where the geared fastener device rotates the geared tip relative to the key hole base to rotate the meshed fastener gear teeth/connector gear teeth and connect the cable connector to the computing device connector. With reference to FIG. 12C, in an embodiment of block 806 and following the meshing of the fastener gear teeth 406a with the connector gear teeth 708b at block 804, the geared fastening device 400 may be rotated in a direction F in order to secure the geared cable connector 708 to the computing device connector 304c. For example, and as will be appreciated by one of skill in the art in possession of the present disclosure, the geared fastening device handle 402 (not visible in FIG. 12C) may be rotated in the direction F in order to rotate the geared tip 406 in the direction F via the geared fastening device shaft 404. Furthermore, due to the meshing of the fastener gear teeth 406a on the geared tip 406 and the connector gear teeth 708b on the geared cable connector 708, the rotation of the geared tip 406 in the direction F will cause the rotation of the geared cable connector 708 in a direction G, securing the geared cable connector 708 to the computing device connector 304c as illustrated in FIG. 13. Further still, while the use of the geared fastener device 400 to secure the geared cable connector 708 to the computing device connector 304c has been described, one of skill in the art in possession of the present disclosure will appreciate how the geared fastener devices 500 and 600 discussed above with reference to FIGS. 5A and 6A may be used to secure the geared cable connector 708 to the computing device connector 304c in a similar manner.

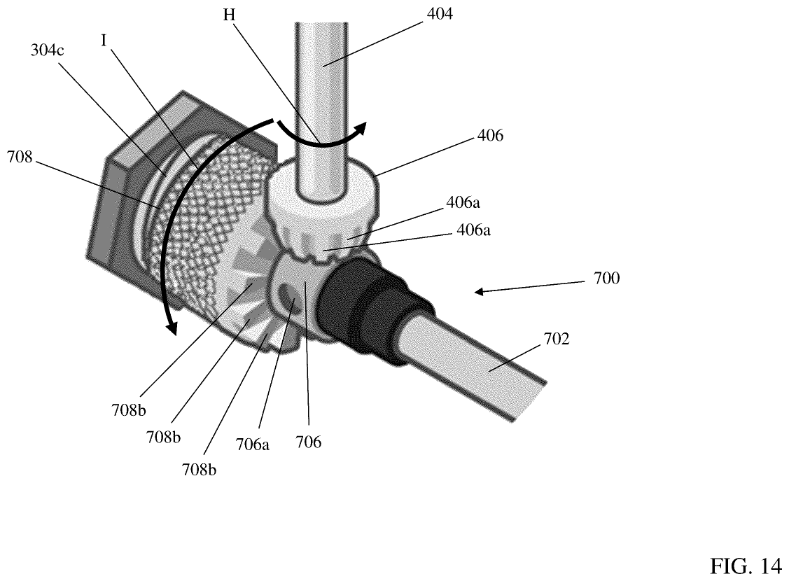

As will be appreciated by one of skill in the art in possession of the present disclosure, following the securing of the geared cable connector 708 to the computing device connector 304c at block 806, data may be transmitted via the cable 702. Furthermore, one of skill in the art in possession of the present disclosure will appreciate how at some point following the transmission of data via the cable 702, it may be desirable to disconnect the cable 702 from the computing device connector 304c. As illustrated in FIG. 14, in such an embodiment, the geared fastening device 400 may be engaged with the key hole 706a such that the fastener gear teeth 406a and the connector gear teeth 708b mesh together (e.g., due to the ability of the geared cable connector 708 to rotate relative to the key hole base 706), similarly as described above. The geared fastening device 400 may then be rotated in a direction H in order to disconnect the geared cable connector 708 from the computing device connector 304c.

For example, and as will be appreciated by one of skill in the art in possession of the present disclosure, the geared fastening device handle 402 (not visible in FIG. 14) may be rotated in the direction H in order to rotate the geared tip 406 in the direction H via the geared fastening device shaft 404. Furthermore, due to the meshing of the fastener gear teeth 406a on the geared tip 406 and the connector gear teeth 708b on the geared cable connector 708, the rotation of the geared tip 406 in the direction H will cause the rotation of the geared cable connector 708 in a direction I, disconnecting the geared cable connector 708 from the computing device connector 304c. However, while the use of the geared fastener device 400 to disconnect the geared cable connector 708 from the computing device connector 304c has been described, one of skill in the art in possession of the present disclosure will appreciate how the geared fastener devices 500 and 600 discussed above with reference to FIGS. 5A and 6A may be used to disconnect the geared cable connector 708 from the computing device connector 304c in a similar manner.

As such, the engagement of the geared tip on the geared fastening device 400 with the key hole 706a and the meshing of the fastener gear teeth 406a on the geared tip 406 with the connector gear teeth 708b on the geared cable connector 708 enables the rotation of the geared cable connector 708 on the computing device connector 304c when the lack of hand/finger access to a conventional cable connector would otherwise prevent a user from fastening or unfastening the that cable connector from the computing device connector 304c.

Thus, systems and methods have been described that provide for the fastening and/or unfastening of a cable connector and a computing device connector utilizing meshed gears. For example, the meshed gear cable connector fastening system of the present disclosure may include a cable. A cable connector is rotatably coupled to the cable and includes connector gear teeth. A key hole base is mounted to the cable adjacent the cable connector such that the key hole base does not rotate independently of the cable. The key hole based defines a key hole that is configured to receive a geared fastener device to mesh fastener gear teeth on a geared fastener device with the connector gear teeth on the cable connector. Rotation of the fastener gear teeth relative to the key hole base to rotate the cable connector via the connector gear teeth meshed with the fastener gear teeth. As such, the fastening (or the unfastening) of a cable connector and a computing device connector is facilitated when, for example, obstructions restrict hand/finger access to the cable connector.

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

What is claimed is:

1. A meshed gear cable connector fastening system, comprising:
a cable;
a cable connector that is rotatably coupled to the cable and that includes connector gear teeth; and
a key hole base that defines a key hole and that is mounted to the cable adjacent the cable connector such that the key hole base does not rotate independently of the cable, wherein the key hole is configured to:
receive a geared fastener device to mesh fastener gear teeth on a geared fastener device with the connector gear teeth on the cable connector; and
allow rotation of the fastener gear teeth relative to the key hole base to rotate the cable connector via the connector gear teeth meshed with the fastener gear teeth.

2. The system of claim 1, wherein the cable connector is a SubMiniature version A (SMA) cable connector.

3. The system of claim 1, wherein the key hole base defines a plurality of key holes in a spaced-apart orientation about its circumference.

4. The system of claim 1, further comprising:
the geared fastener device including an integrated fastener gear that provides the fastener gear teeth.

5. The system of claim 1, further comprising:
a fastener gear bit that provides the fastener gear teeth and that is configured to connect to a multi-bit fastener device to provide the gear fastener device.

6. The system of claim 1, further comprising:
the geared fastener device including a fastener gear that provides the fastener gear teeth and that is pivotally coupled to the geared fastener device.

7. An Information Handling System (IHS), comprising:
a chassis;
a processing system that is housed in the chassis;
a memory system that is housed in the chassis, that is coupled to the processing system, and that includes instructions that, when executed by the processing system, cause the processing system to provide a processing engine that is configured to perform processing functionality;
an IHS connector that is accessible on the chassis and that is coupled to the processing system; and
a meshed gear cable connector fastening system, including:
a cable;
a cable connector that is rotatably coupled to the cable, that includes connector gear teeth, and that is connected to the IHS connector; and
a key hole base that defines a key hole and that is mounted to the cable adjacent the cable connector such that the key hole base does not rotate independently of the cable, wherein the key hole is configured to:
receive a geared fastener device to mesh fastener gear teeth on a geared fastener device with the connector gear teeth on the cable connector; and
allow rotation of the fastener gear teeth relative to the key hole base to rotate the cable connector via the connector gear teeth meshed with the fastener gear teeth.

8. The IHS of claim 7, wherein the cable connector is a SubMiniature version A (SMA) cable connector.

9. The IHS of claim 7, wherein the key hole base defines a plurality of key holes in a spaced-apart orientation about its circumference.

10. The IHS of claim 7, further comprising:
the geared fastener device including an integrated fastener gear that provides the fastener gear teeth.

11. The IHS of claim 7, further comprising:
a fastener gear bit that provides the fastener gear teeth and that is configured to connect to a multi-bit fastener device to provide the gear fastener device.

12. The IHS of claim 7, further comprising:
the geared fastener device including a fastener gear that provides the fastener gear teeth and that is pivotally coupled to the geared fastener device.

13. The IHS of claim 7, wherein the chassis includes an outer surface and defines a recessed portion, and wherein the IHS connector is located in the recessed portion such that the chassis obstructs access to a perimeter of the cable connector while the connector gear teeth are accessible via an entrance to the recessed portion.

14. A method for meshed gear fastening a cable connector to a computing device, comprising:
engaging, by a cable connector that includes connector gear teeth and that is rotatably coupled to an end of a cable, with a computing device connector on a computing device;
receiving, by a key hole defined by a key hole base that is mounted to the cable adjacent the cable connector such that the key hole base does not rotate independently of the cable, a geared fastener device to mesh fastener gear teeth on the geared fastener device with the connector gear teeth on the cable connector; and
rotating, by the cable connector, in response to the rotation of the fastener gear teeth relative to the key hole while the fastener gear teeth are meshed with the connector gear teeth, relative to the cable such that the cable connector connects to the computing device connector.

15. The method of claim 14, wherein the cable connector is a SubMiniature version A (SMA) cable connector.

16. The method of claim 14, wherein the key hole base defines a plurality of key holes in a spaced-apart orientation about its circumference.

17. The method of claim 14, further comprising:
the geared fastener device including an integrated fastener gear that provides the fastener gear teeth.

18. The method of claim 14, further comprising:
connecting, by a fastener gear bit, that provides the fastener gear teeth and that is configured to connect to a multi-bit screwdriver, to the geared fastener device.

19. The method of claim 14, further comprising:
pivoting, by a fastener gear that is coupled to the geared fastener device and that provides the fastener gear teeth.

20. The method of claim 14, wherein the chassis includes an outer surface and defines a recessed portion, and wherein the IHS connector is located in the recessed portion such that the chassis obstructs access to a perimeter of the cable connector while the connector gear teeth are accessible via an entrance to the recessed portion.
